(19) United States
(12) Patent Application Publication
(10) Pub. No.: US 2026/0088238 A1
(43) Pub. Date: Mar. 26, 2026

(54) TECHNIQUES FOR IMPROVING VISIBILTY OF TOUCH SENSITIVE BUTTONS ON COMPUTING DEVICES IN BRIGHT ENVIRONMENTS

(71) Applicant: Intel Corporation, Santa Clara, CA (US)

(72) Inventors: Shantanu D. Kulkarni, Hillsboro, OR (US); Jeff Ku, Taipei City (TW); Surya Pratap Mishra, Portland, OR (US)

(73) Assignee: Intel Corporation, Santa Clara, CA (US)

(21) Appl. No.: 18/894,999

(22) Filed: Sep. 24, 2024

(51) Int. Cl. H01H 13/83; G06F 1/16

(52) U.S. Cl. CPC H01H 13/83; G06F 1/1671

(57) ABSTRACT

In one embodiment, a computing device includes a keyboard, a plurality of openings adjacent to the keyboard with at least one light emitting element positioned below each respective opening, and a flap above the plurality of openings. The flap is moveable between a first position that is generally parallel to the keyboard and a second position that is at an angle less than 90 degrees with respect to the keyboard. The flap includes touch sensing circuitry in areas adjacent to the respective openings and a liquid crystal layer that can be controlled to be generally transparent in the first position and generally opaque in the second position. The computing device may also include photochromatic paint adjacent to the openings.

### BACKGROUND

Many laptop computer manufacturers have started including a row of capacitive buttons near the keyboard to provide enhanced functionality and/or better volume efficiency. However, in many instances, these capacitive buttons are not very visible in bright environments (e.g., sunny outdoor environments). In addition, these buttons tend to be located the forehead area of the device (i.e., close to the processor(s)), which can already be hot to the touch. Additional heat, e.g., from the sun in bright conditions, can serve to exacerbate this issue.

### BRIEF DESCRIPTION OF THE DRAWINGS

FIG. 1 illustrates an example computing device in which aspects of the present disclosure may be incorporated.

FIGS. 2A-2B illustrate side views of an example embodiment of the present disclosure.

FIGS. 3A-3B illustrate top views of the example embodiment of FIGS. 2A-2B.

FIGS. 4A-4B illustrate top views of another example embodiment of the present disclosure.

FIG. 5 illustrates a simplified block diagram of a computing device in which aspects of the present disclosure may be incorporated.

FIG. 6 is a block diagram of computing device components which may be included in a mobile computing device incorporating aspects of the present disclosure.

### DETAILED DESCRIPTION

In the following description, specific details are set forth, but aspects of the technologies described herein may be practiced without these specific details. Well-known circuits, structures, and techniques have not been shown in detail to avoid obscuring an understanding of this description. “An embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact. Terms modified by the word “substantially” include arrangements, orientations, spacings, or positions that vary slightly from the meaning of the unmodified term. For example, description of a lid of a mobile computing device that can rotate to substantially 360 degrees with respect to a base of the mobile computing includes lids that can rotate to within several degrees of 360 degrees with respect to a device base.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to aspects of the present disclosure, are synonymous.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims. While aspects of the present disclosure may be used in any suitable type of computing device, the examples below describe example mobile computing devices/environments in which aspects of the present disclosure can be implemented.

### Improving Visibility of Touch Sensitive Buttons on Computing Devices in Bright Environments

Aspects of the present disclosure relate to solutions for improving the visibility of touch sensitive (e.g., capacitive) buttons on computing device (e.g., laptop computers) in bright ambient lighting conditions. As previously mentioned, computer manufacturers have started including capacitive buttons near keyboards to provide additional functionality, but these buttons are usually not very visible in bright environments (e.g., sunny outdoor environments). Some embodiments, for instance, may include a photochromatic paint near, around, or adjacent to the capacitive buttons that darkens in the presence of ultraviolet (UV) light to provide additional contrast and viewability. In addition, some embodiments may include a moveable flap that can be raised in bright environments to shade the capacitive buttons and provide additional viewability. The flap may be formed of a transparent material and may include the capacitive touch sensing circuitry with which the user interacts to activate the buttons. In addition, the flap may include darkening means (e.g., liquid crystals, such as polymer dispersed liquid crystals (PDLC) or photochromatic paint) for providing shading to the button icons or indicators on the computing device.

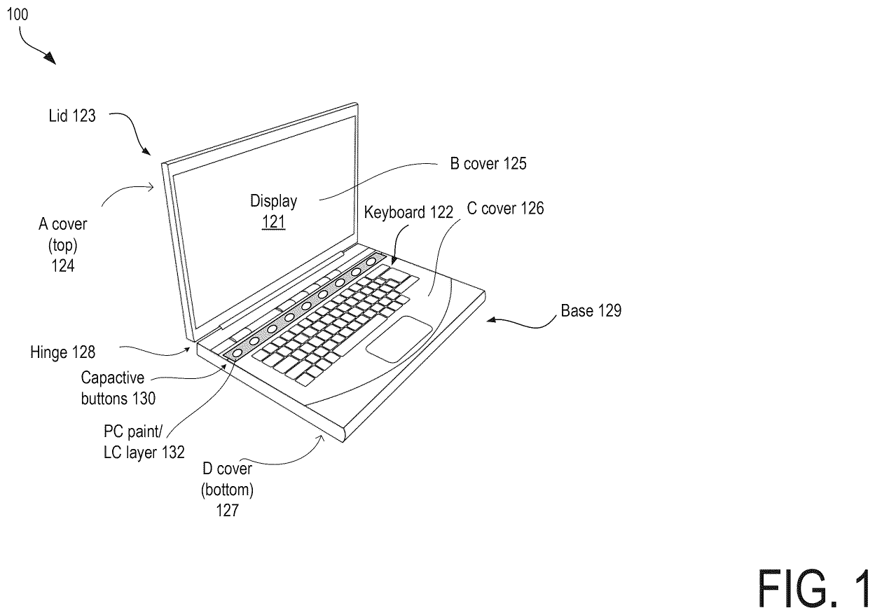

FIG. 1 illustrates an example laptop computing device 100 in which aspects of the present disclosure may be incorporated. The computing device 100 can be a laptop (as shown) or another type of mobile computing device with a similar form factor, such as a foldable tablet or smartphone. In some embodiments, embodiments of present disclosure may be incorporated into a free-standing display monitor, which may be connected to a computing device that outputs image data to the display.

The computing device 100 includes a housing, which includes a lid 123 with an A cover 124 that is a “world-facing” surface of the lid 123 when the computing device 100 is in a closed configuration and a B cover 125 that comprises a user-facing display 121 when the lid 123 is open (e.g., as shown). The computing device 100 also includes a base 129 with a C cover 126 that includes a keyboard 122 that is upward facing when the device 100 is an open configuration (e.g., as shown) and a D cover 127 that forms the bottom of the base 129. In some embodiments, the base 129 includes the primary computing resources (e.g., host processor unit(s), graphics processing unit (GPU)) of the device 100, along with a battery, memory, and storage, and communicates with the lid 123 via wires that pass through a hinge 128 that connects the base 129 with the lid 123. In some embodiments, the computing device 100 can be a dual display device with a second display comprising a portion of the C cover 126. For example, in some embodiments, an “always-on” display (AOD) can occupy a region of the C cover below the keyboard that is visible when the lid 123 is closed. In other embodiments, a second display covers most of the surface of the C cover and a removable keyboard can be placed over the second display or the second display can present a virtual keyboard to allow for keyboard input.

In addition, the computing device 100 includes a row of touch sensitive (e.g., capacitive) buttons 130 at the forehead area of the C cover 126, between the keyboard 122 and the hinge 128. In the example shown, there is also one or both of photochromatic (PC) paint or a liquid crystal (LC) layer 132 around each of the touch sensitive buttons 130. The photochromatic paint may include materials that cause the paint to darken in appearance in the presence of UV light. In some embodiments, for example, the PC paint may be the same or similar color as the material used for the C cover 126 when there is little to no UV ambient light present; however, in the presence of UV light, the PC paint may darken (e.g., as shown) and provide additional contrast against the touch sensitive buttons 130, allowing them to be more visible in bright environments. The LC layer may be configured to be generally transparent in low ambient UV light environments and to be generally opaque in high ambient UV light environments to provide similar contrast enhancement as described above with respect to the PC paint. The LC layer may include openings therein to allow visibility to the underlying buttons 130.

The computing device 100 may also include, a flap that can move (e.g., manually, via a push-push mechanism, electronically, or otherwise) between a first position that is generally parallel or co-planar with the base 129/C cover 126 and a second position that is at an acute angle less than 90 degrees (e.g., at approximately 30-40 degrees) with respect to the base 129/C cover 126, which can allow for shading of the touch sensitive buttons as described further below.

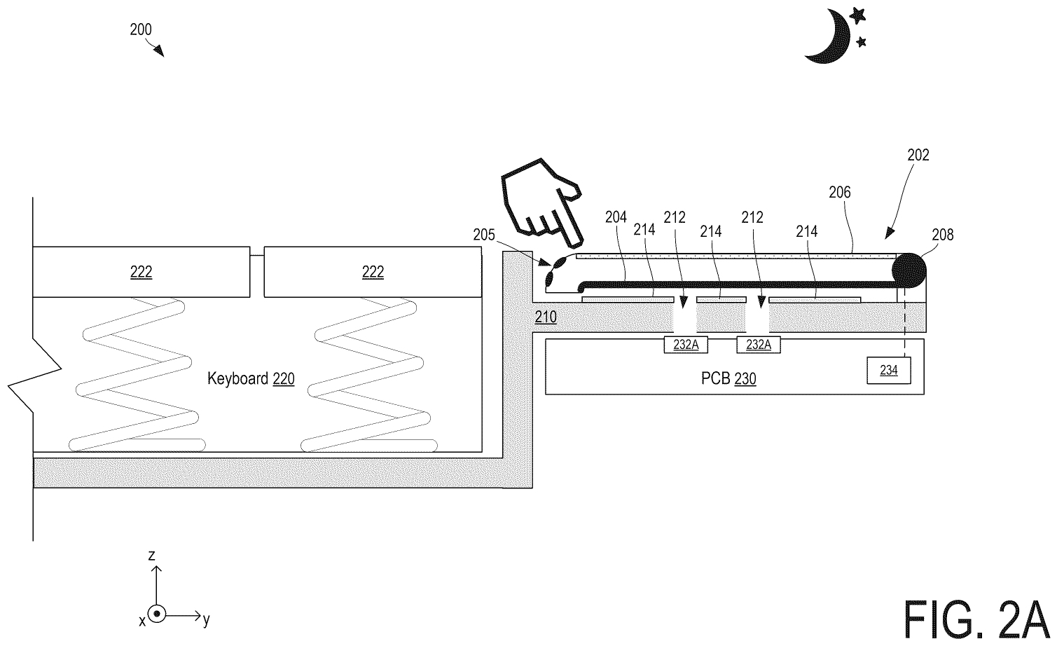

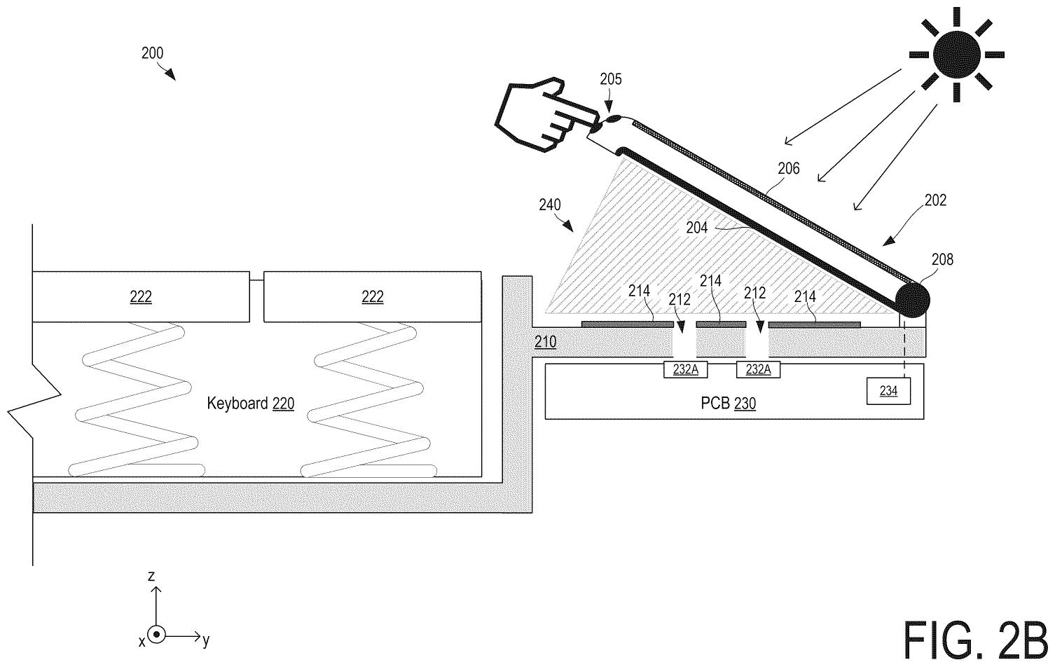

FIGS. 2A-2B illustrate side views of an example embodiment of the present disclosure. In particular, FIGS. 2A-2B illustrate an example computer system 200 incorporating aspects of the present disclosure in a dark environment and sunny environment, respectively. The example computer system 200 includes a flap 202 attached to a C cover 210 via a hinge 208, adjacent to keys 222 of a keyboard 220 of the computer system (similar to the example shown in FIG. 1). The body of the flap 202 may be a transparent material, such as, for example, glass, acrylic, or poly(methyl methacrylate) (PMMA). In the example shown, the keys 222 are spring-actuated mechanical keys; however, the keys 222 may be mechanically actuated in another mechanical manner (e.g., by butterfly- or scissor-mechanisms). In other embodiments, the keys 222 are not mechanical keys, and may be implemented as touch sensitive keys.

The computer system includes a printed circuit board (PCB) 230 under the C cover 210 as shown. The PCB 230 includes light emitting elements 232 that are positioned under openings 212 within the C cover 210. The openings 212 may be in any suitable shape, and may be icons to indicate a function of a touch sensitive (e.g., capacitive) button of the computer system 200 (e.g., play/pause, volume up/down, or other function buttons (e.g., F1-F12)), and the light emitting elements 232 may illuminate similar to a backlight for the keys 222 of the keyboard 220 to provide visibility in darker conditions. In other embodiments, the light emitting elements may be positioned within the openings 212, or may be coupled directly to the C cover 210 in the position of the openings 212 (e.g., on a surface of the C cover 210).

In some embodiments, the PCB 230 also includes circuitry 234 to couple to the touch sensing layer 204 and provide the touch sensing detection/control functionality for the computing system 200. For example, the PCB 230 may detect a touch by the user, via the touch sensing layer 204, above the opening 212, and may communicate actuation of the button function corresponding with the function indicated by the opening 212 to a processor of the computer system 200. Moreover, in some embodiments, the circuitry 234 of the PCB 230 may be able to control the liquid crystal layer 206 to switch between generally transparent and generally opaque states, as described further below. In some embodiments, the PCB 230 also receives input from the keys 222 of the keyboard.

The computer system 200 includes photochromatic paint 214 in areas adjacent to the openings 212, which can aid in providing contrast in brighter conditions as described above. In certain embodiments, the photochromatic paint 214 may appear similar to or the same as the color of the C cover 210 in darker or low UV light conditions (e.g., as shown in FIG. 2A), and may darken in the presence of UV light (e.g., as shown in FIG. 2B) to provide contrast for the lighting from the light emitting elements 232 (since such lighting may not be very visible in bright conditions with a relatively light colored C cover 210).

The flap 202 includes a touch sensing layer 204 on the flap 202, e.g., on the underside of the flap 202 as shown in FIGS. 2A-2B. The touch sensing layer 204 may include capacitive or other types of touch sensing circuitry to detect user touch input, e.g., for selection of a function indicated by the opening 212 (e.g., play/pause, volume up/down, etc.). The touch sensing layer 204 may be located in another location on the flap 202 in other embodiments. Certain embodiments may include respective touch sensing layers 204 for each function button of the computer system, and each respective touch sensing layer 204 may be located on a location of the flap 202 immediately above the opening 212 representing such function. In this way, when the flap 202 is down (i.e., generally parallel with the C cover 210) as shown in FIG. 2A, the flap 202 may function similar to a row of capacitive buttons on existing computer designs.

The flap 202 also includes a liquid crystal layer 206, e.g., on a top side of the flap 202 as shown in FIGS. 2A-2B. The liquid crystal layer 206 may be configured to be generally transparent (e.g., with >80% transmissivity) in one state (e.g., when an electrical voltage or current is applied) and to be generally opaque (e.g., <10% transmissivity) in another state (e.g., when no electrical voltage or current is applied). In certain embodiments, for example, the liquid crystal layer 206 includes a layer of polymer dispersed liquid crystals (PDLC) that is generally transparent when voltage/current is applied (on) and generally opaque when the voltage/current is turned off. Thus, when the flap 202 is down (i.e., generally parallel with the C cover 210) as shown in FIG. 2A, the liquid crystal layer 206 may be set to be generally transparent so that a user can see the light emitting elements 232 below the flap 202.

In some embodiments, the liquid crystal layer 206 may be over an entirety of the top portion of the flap 202, while in other embodiments, the liquid crystal layer 206 may have openings therein or may be otherwise patterned to allow for the openings 212 to be visible when the liquid crystal layer 206 is configured as opaque. In this way, the liquid crystal layer 206 can provide the same or similar contrast and visibility enhancement as the photochromatic paint 214 when the flap 202 is in the position shown in FIG. 2A.

In the presence of UV light, e.g., as shown in FIG. 2B, the photochromatic paint 214 may darken as shown. In addition, a user can lift the flap 202 to a lifted position (e.g., at an acute angle with respect to the C cover 210/keyboard 220 as shown FIG. 2B) and the liquid crystal layer 206 may be set to darken to shade (240) the area of the C cover 210 with the openings 212 and provide better visibility of the light from the light emitting elements 232. The flap 202 may be curved at an end opposite the end attached to the C cover via the hinge 208 as shown, and may include indicators 205 on the curved end with which the user may interact with to activate the various button functions. For instance, if a user wished to activate the function indicated by the opening 212, they may touch the indicator 205 on the curved end of the flap 202, and the touch sensing layer 204 may be able to sense such touch input and activate the particular function. The indicators 205 may be purely visual, e.g., paint on the flap, or may be physical, e.g., may protrude from the flap as shown for tactile feedback to the user.

The flap 202 may be moveable into the position shown in FIG. 2B by any suitable means. As one example, the user may manually move the flap 202 into the position shown. As another example, the user may use a push-push mechanism, whereby the user may push the flap 202 when in the position shown in FIG. 2A and the flap 202 may raise to the position shown in FIG. 2B (via hydraulic or other mechanisms in the hinge). To close the flap back to the position shown in FIG. 2A, the user may push the flap 202 down again and it may lock into place via the push-push mechanism. As yet another example, the flap 202 may be controlled by a processor or other device of the computer system 200 to move between the positions shown. For example, the computer system 200 may include a light sensor and may be configured to move the flap 202 between the positions shown (and activate the liquid crystal layer 206) based on ambient lighting conditions.

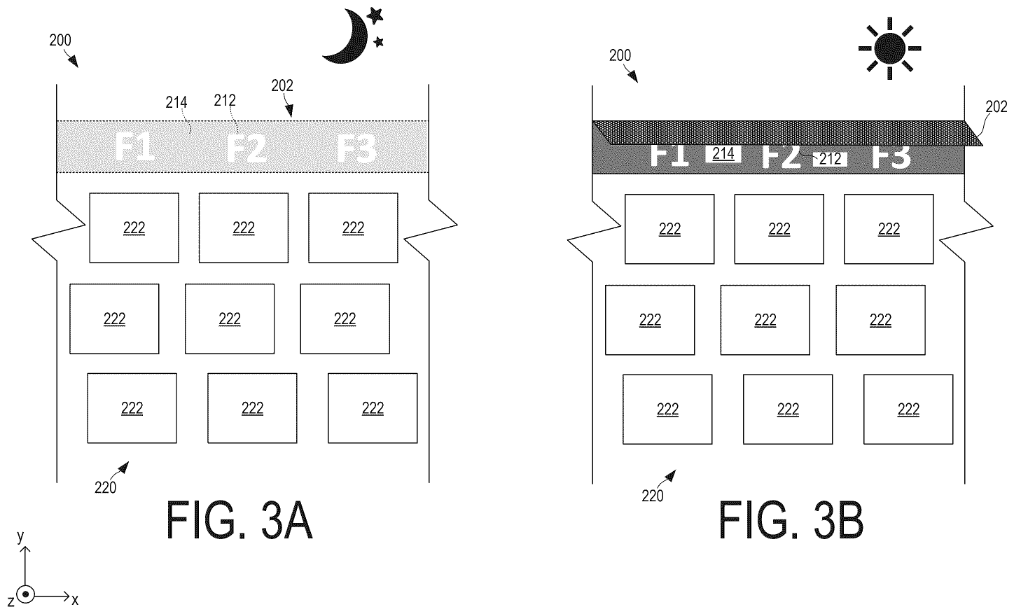

FIGS. 3A-3B illustrate top views of the example embodiment of FIGS. 2A-2B. As shown, there is a row of touch sensitive buttons adjacent to a set of keys 222 of the keyboard 220. There are openings 212 under the flap 202 (which is transparent and in the down position in the example shown in FIG. 3A, and opaque and in the raised position in the example shown in FIG. 3B) to indicate various functions to be performed by the buttons.

There is also photochromatic paint 214 in the areas adjacent to the openings 212, which darkens in the presence of UV light as shown in FIG. 3B.

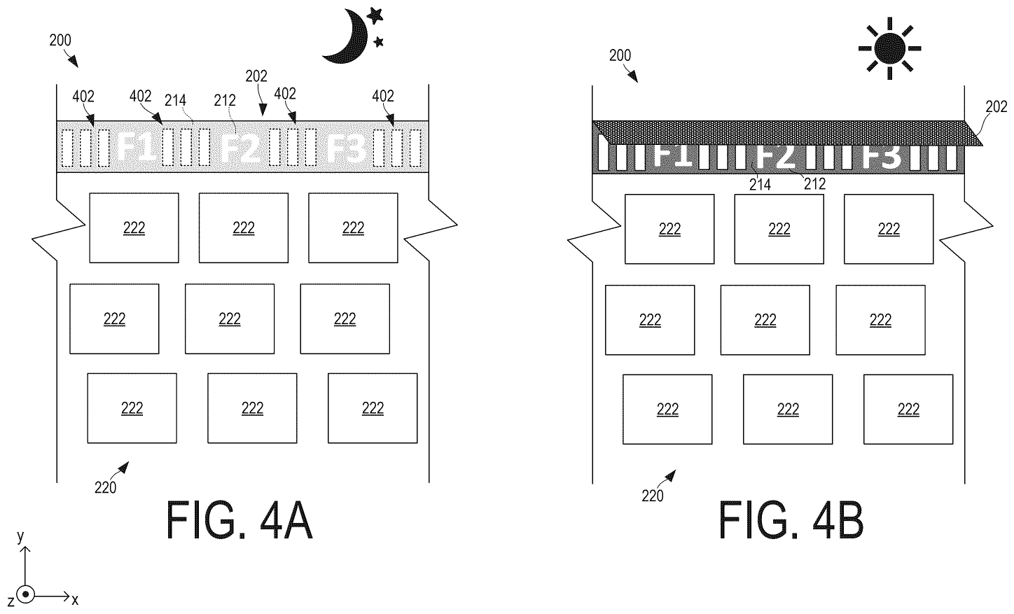

FIGS. 4A-4B illustrate top views of another example embodiment of the present disclosure. In particular, FIGS. 4A-4B illustrate the example computer system 200 shown in FIGS. 2A-2B (and FIGS. 3A-3B), but with vent openings 402 in the C cover adjacent to the openings 212. In certain embodiments, the vent openings 402 may be positioned approximately above processors and/or heat exchangers of the computer system 200. Thus, the vent openings 402 may allow for additional cooling of the computer system 200 when the flap 202 is in the raised position shown in FIG. 4B, which may be quite beneficial if/when the computer system 200 is outside in a sunny and/or hot environment.

### Example Computing Systems

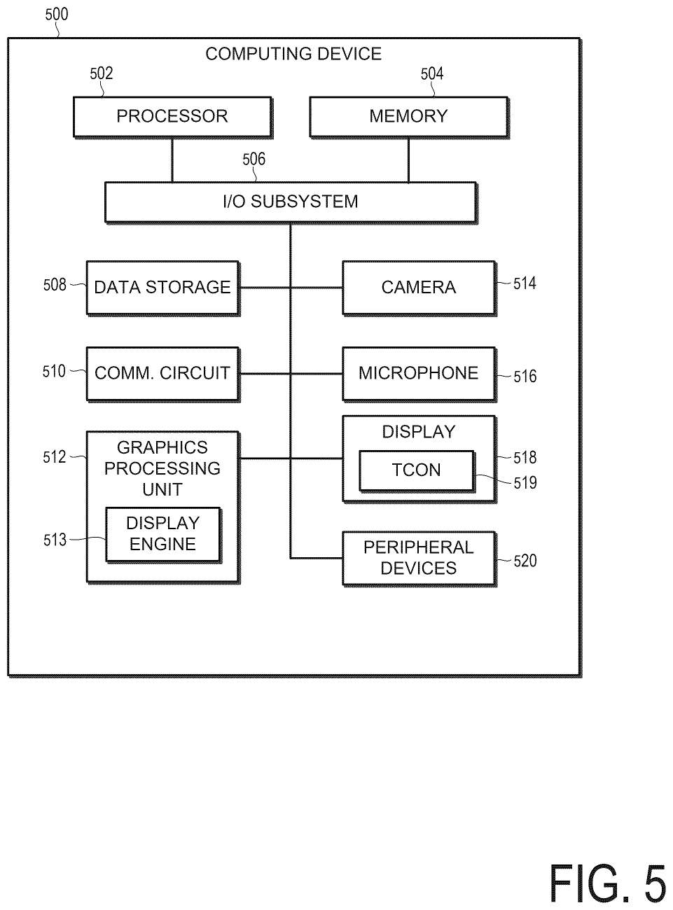

FIG. 5 illustrates a simplified block diagram of a computing device in which aspects of the present disclosure may be incorporated. The computing device 500 for selective updating of a display is shown. In use, the illustrative computing device 500 determines one or more regions of a display to be updated. For example, a user may move a cursor and a clock may change from one frame to the next, requiring an update to two regions of a display. The computing device 500 sends update regions from a source to a sink in the display 518 over a link. In the illustrative embodiment, the source does not have direct access to the link port while the sink does have direct access to the link port. The source can send an indication that a particular update message is the last message to be sent for the current frame, after which the source will be entering an idle period without sending update messages. The sink can then place the link in a low-power state to reduce power usage.

The computing device 500 may be embodied as any type of computing device. For example, the computing device 500 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, and/or any other computing device. In some embodiments, the computing device 500 may be located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

The illustrative computing device 500 includes a processor 502, a memory 504, an input/output (I/O) subsystem 506, data storage 508, a communication circuit 510, a graphics processing unit 512, a camera 514, a microphone 516, a display 518, and one or more peripheral devices 520. In some embodiments, one or more of the illustrative components of the computing device 500 may be incorporated in, or otherwise form a portion of, another component. For example, the memory 504, or portions thereof, may be incorporated in the processor 502 in some embodiments. In some embodiments, one or more of the illustrative components may be physically separated from another component.

The processor 502 may be embodied as any type of processor capable of performing the functions described herein. For example, the processor 502 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 504 may be embodied as any type of volatile or non-volatile memory or data storage capable of performing the functions described herein. In operation, the memory 504 may store various data and software used during operation of the computing device 500 such as operating systems, applications, programs, libraries, and drivers. The memory 504 is communicatively coupled to the processor 502 via the I/O subsystem 506, which may be embodied as circuitry and/or components to facilitate input/output operations with the processor 502, the memory 504, and other components of the computing device 500. For example, the I/O subsystem 506 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 506 may connect various internal and external components of the computing device 500 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 506 may form a portion of a system-on-a-chip (SoC) and be incorporated, along with the processor 502, the memory 504, and other components of the computing device 500 on a single integrated circuit chip.

The data storage 508 may be embodied as any type of device or devices configured for the short-term or long-term storage of data. For example, the data storage 508 may include any one or more memory devices and circuits, memory cards, hard disk drives, solid-state drives, or other data storage devices.

The communication circuit 510 may be embodied as any type of interface capable of interfacing the computing device 500 with other computing devices, such as over one or more wired or wireless connections. In some embodiments, the communication circuit 510 may be capable of interfacing with any appropriate cable type, such as an electrical cable or an optical cable. The communication circuit 510 may be configured to use any one or more communication technology and associated protocols (e.g., Ethernet, Bluetooth®, Wi-Fi®, WiMAX, near field communication (NFC), etc.). The communication circuit 510 may be located on silicon separate from the processor 502, or the communication circuit 510 may be included in a multi-chip package with the processor 502, or even on the same die as the processor 502. The communication circuit 510 may be embodied as one or more add-in-boards, daughtercards, network interface cards, controller chips, chipsets, specialized components such as a field-programmable gate array (FPGA) or application-specific integrated circuit (ASIC), or other devices that may be used by the computing device 500 to connect with another computing device. In some embodiments, communication circuit 510 may be embodied as part of a system-on-a-chip (SoC) that includes one or more processors or included on a multichip package that also contains one or more processors. In some embodiments, the communication circuit 510 may include a local processor (not shown) and/or a local memory (not shown) that are both local to the communication circuit 510. In such embodiments, the local processor of the communication circuit 510 may be capable of performing one or more of the functions of the processor 502 described herein. Additionally or alternatively, in such embodiments, the local memory of the communication circuit 510 may be integrated into one or more components of the computing device 500 at the board level, socket level, chip level, and/or other levels.

The graphics processing unit 512 is configured to perform certain computing tasks, such as video or graphics processing. The graphics processing unit 512 may be embodied as one or more processors, data processing unit, field-programmable gate arrays (FPGAs), application-specific integrated circuits (ASICs), and/or any combination of the above. In some embodiments, the graphics processing unit 512 may send frames or partial update regions to the display 518. For instance, the example graphics processing unit 512 includes a display engine 513, which may be embodied as hardware, firmware, software, virtualized hardware, emulated architecture, and/or a combination thereof, and is configured to determine frames to be sent to the display 518 and send the images to the display 518. In the illustrative embodiment, the display engine 513 is part of the graphics processing unit 512. In other embodiments, the display engine 513 may be part of the processor 502 or other component of the device 500.

In certain embodiments, the display engine 513 may include circuitry to implement aspects of the present disclosure, e.g., circuitry to implement the computational aspects described with respect to FIG. 1 above. For example, the display engine 513 may access frames stored in the memory 504, enhance the frames as described above, and then stream the frames to the display 518.

The camera 514 may include one or more fixed or adjustable lenses and one or more image sensors. The image sensors may be any suitable type of image sensors, such as a CMOS or CCD image sensor. The camera 514 may have any suitable aperture, focal length, field of view, etc. For example, the camera 514 may have a field of view of 60-110° in the azimuthal and/or elevation directions.

The microphone 516 is configured to sense sound waves and output an electrical signal indicative of the sound waves. In the illustrative embodiment, the computing device 500 may have more than one microphone 516, such as an array of microphones 516 in different positions.

The display 518 may be embodied as any type of display on which information may be displayed to a user of the computing device 500, such as a touchscreen display, a liquid crystal display (LCD), a thin film transistor LCD (TFT-LCD), a light-emitting diode (LED) display, an organic light-emitting diode (OLED) display, a cathode ray tube (CRT) display, a plasma display, an image projector (e.g., 2D or 3D), a laser projector, a heads-up display, and/or other display technology. The display 518 may have any suitable resolution, such as 7680×4320, 3840×2160, 1920×1200, 1920×1080, etc.

The display 518 includes a timing controller (TCON) 519, which includes circuitry to convert video data received from the graphics processing unit 512 into signals that drive a panel of the display 518. In some embodiments, the TCON 519 may also include circuitry to implement one or more aspects of the present disclosure. For example, the TCON 519 may include circuitry to implement the computational aspects described with respect to FIG. 1 above. For example, the TCON 519 may enhance frames received from the graphics processing unit 512 and stream the frames to the panel of the display 518.

In some embodiments, the computing device 500 may include other or additional components, such as those commonly found in a computing device. For example, the computing device 500 may also have peripheral devices 520, such as a keyboard, a mouse, a speaker, an external storage device, etc. In some embodiments, the computing device 500 may be connected to a dock that can interface with various devices, including peripheral devices 520. In some embodiments, the peripheral devices 520 may include additional sensors that the computing device 500 can use to monitor the video conference, such as a time-of-flight sensor or a millimeter-wave sensor.

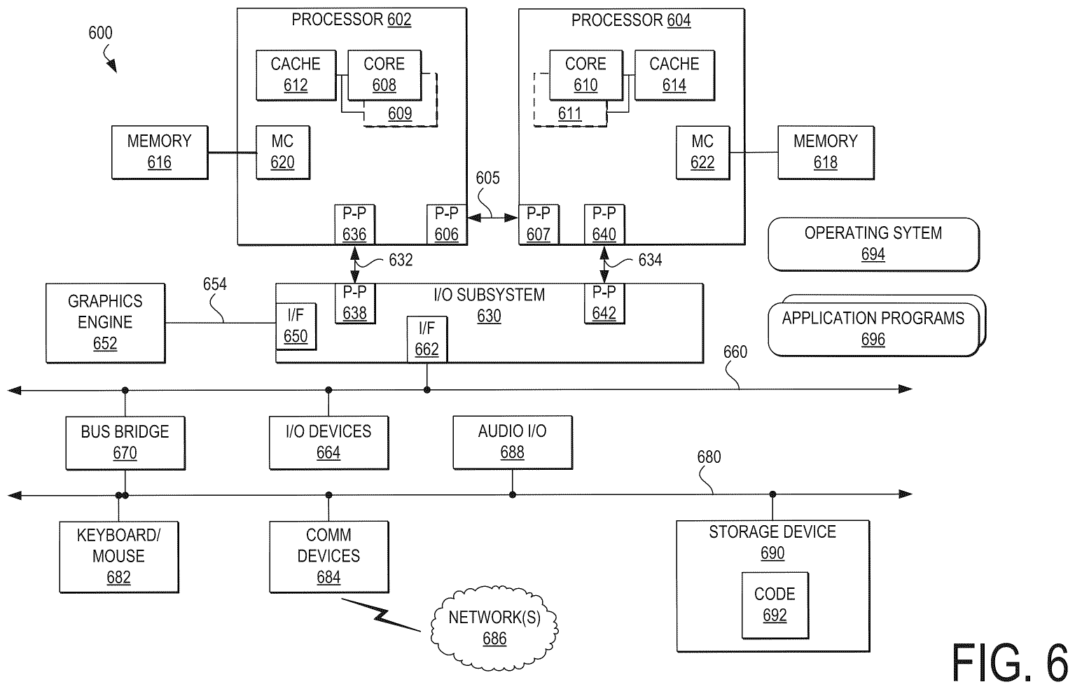

FIG. 6 is a block diagram of computing device components which may be included in a mobile computing device incorporating aspects of the present disclosure. Generally, components shown in FIG. 6 can communicate with other shown components, although not all connections are shown, for ease of illustration. The components 600 comprise a multiprocessor system comprising a first processor 602 and a second processor 604 and is illustrated as comprising point-to-point (P-P) interconnects. For example, a point-to-point (P-P) interface 606 of the processor 602 is coupled to a point-to-point interface 607 of the processor 604 via a point-to-point interconnection 605. It is to be understood that any or all of the point-to-point interconnects illustrated in FIG. 6 can be alternatively implemented as a multi-drop bus, and that any or all buses illustrated in FIG. 6 could be replaced by point-to-point interconnects.

As shown in FIG. 6, the processors 602 and 604 are multicore processors. Processor 602 comprises processor cores 608 and 609, and processor 604 comprises processor cores 610 and 611. Processor cores 608-611 can execute computer-executable instructions in a manner similar to that discussed below, or in other manners.

Processors 602 and 604 further comprise at least one shared cache 612 and 614, respectively. The shared caches 612 and 614 can store data (e.g., instructions) utilized by one or more components of the processor, such as the processor cores 608-609 and 610-611. The shared caches 612 and 614 can be part of a memory hierarchy for the device. For example, the shared cache 612 can locally store data that is also stored in a memory 616 to allow for faster access to the data by components of the processor 602. In some embodiments, the shared caches 612 and 614 can comprise multiple cache layers, such as level 1 (L1), level 2 (L2), level 3 (L3), level 4 (L4), and/or other caches or cache layers, such as a last level cache (LLC).

Although two processors are shown, the device can comprise any number of processors or other compute resources. Further, a processor can comprise any number of processor cores. A processor can take various forms such as a central processing unit, a controller, a graphics processor, an accelerator (such as a graphics accelerator, digital signal processor (DSP), or artificial intelligence (AI) accelerator)). A processor in a device can be the same as or different from other processors in the device. In some embodiments, the device can comprise one or more processors that are heterogeneous or asymmetric to a first processor, accelerator, field programmable gate array (FPGA), or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 602 and 604 reside in a multi-chip package. As used herein, the terms “processor unit” and “processing unit” can refer to any processor, processor core, component, module, engine, circuitry or any other processing element described herein. A processor unit or processing unit can be implemented in hardware, software, firmware, or any combination thereof capable of.

Processors 602 and 604 further comprise memory controller logic (MC) 620 and 622. As shown in FIG. 6, MCs 620 and 622 control memories 616 and 618 coupled to the processors 602 and 604, respectively. The memories 616 and 618 can comprise various types of memories, such as volatile memory (e.g., dynamic random-access memories (DRAM), static random-access memory (SRAM)) or non-volatile memory (e.g., flash memory, solid-state drives, chalcogenide-based phase-change non-volatile memories). While MCs 620 and 622 are illustrated as being integrated into the processors 602 and 604, in alternative embodiments, the MCs can be logic external to a processor, and can comprise one or more layers of a memory hierarchy.

Processors 602 and 604 are coupled to an Input/Output (I/O) subsystem 630 via P-P interconnections 632 and 634. The point-to-point interconnection 632 connects a point-to-point interface 636 of the processor 602 with a point-to-point interface 638 of the I/O subsystem 630, and the point-to-point interconnection 634 connects a point-to-point interface 640 of the processor 604 with a point-to-point interface 642 of the I/O subsystem 630. Input/Output subsystem 630 further includes an interface 650 to couple I/O subsystem 630 to a graphics module 652, which can be a high-performance graphics module. The I/O subsystem 630 and the graphics module 652 are coupled via a bus 654. Alternately, the bus 654 could be a point-to-point interconnection.

Input/Output subsystem 630 is further coupled to a first bus 660 via an interface 662. The first bus 660 can be a Peripheral Component Interconnect (PCI) bus, a PCI Express (PCIe) bus, another third generation I/O (input/output) interconnection bus or any other type of bus.

Various I/O devices 664 can be coupled to the first bus 660. A bus bridge 670 can couple the first bus 660 to a second bus 680. In some embodiments, the second bus 680 can be a low pin count (LPC) bus. Various devices can be coupled to the second bus 680 including, for example, a keyboard/mouse 682, audio I/O devices 688 and a storage device 690, such as a hard disk drive, solid-state drive or other storage device for storing computer-executable instructions (code) 692. The code 692 can comprise computer-executable instructions for performing technologies described herein. Additional components that can be coupled to the second bus 680 include communication device(s) or components 684, which can provide for communication between the device and one or more wired or wireless networks 686 (e.g. Wi-Fi, cellular or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

The device can comprise removable memory such as flash memory cards (e.g., SD (Secure Digital) cards), memory sticks, Subscriber Identity Module (SIM) cards). The memory in the computing device (including caches 612 and 614, memories 616 and 618 and storage device 690) can store data and/or computer-executable instructions for executing an operating system 694, or application programs 696. Example data includes web pages, text messages, images, sound files, video data, sensor data, or other data sets to be sent to and/or received from one or more network servers or other devices by the device via one or more wired or wireless networks, or for use by the device. The device can also have access to external memory (not shown) such as external hard drives or cloud-based storage.

The operating system 694 can control the allocation and usage of the components illustrated in FIG. 6 and support one or more application programs 696. The application programs 696 can include common mobile computing device applications (e.g., email applications, calendars, contact managers, web browsers, messaging applications) as well as other computing applications.

The device can support various input devices, such as a touchscreen, microphones, cameras (monoscopic or stereoscopic), trackball, touchpad, trackpad, mouse, keyboard, proximity sensor, light sensor, pressure sensor, infrared sensor, electrocardiogram (ECG) sensor, PPG (photoplethysmogram) sensor, galvanic skin response sensor, and one or more output devices, such as one or more speakers or displays. Any of the input or output devices can be internal to, external to or removably attachable with the device. External input and output devices can communicate with the device via wired or wireless connections.

In addition, the computing device can provide one or more natural user interfaces (NUIs). For example, the operating system 694 or application programs 696 can comprise speech recognition as part of a voice user interface that allows a user to operate the device via voice commands. Further, the device can comprise input devices and components that allows a user to interact with the device via body, hand, or face gestures.

The device can further comprise one or more communication components 684. The components 684 can comprise wireless communication components coupled to one or more antennas to support communication between the device and external devices. Antennas can be located in a base, lid, or other portion of the device. The wireless communication components can support various wireless communication protocols and technologies such as Near Field Communication (NFC), IEEE 1002.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device can further include at least one input/output port (which can be, for example, a USB, IEEE 1394 (FireWire), Ethernet and/or RS-232 port) comprising physical connectors; a power supply (such as a rechargeable battery); a satellite navigation system receiver, such as a GPS receiver; a gyroscope; an accelerometer; and a compass. A GPS receiver can be coupled to a GPS antenna. The device can further include one or more additional antennas coupled to one or more additional receivers, transmitters and/or transceivers to enable additional functions.

FIG. 6 illustrates one example computing device architecture. Computing devices based on alternative architectures can be used to implement technologies described herein. For example, instead of the processors 602 and 604, and the graphics module 652 being located on discrete integrated circuits, a computing device can comprise a SoC (system-on-a-chip) integrated circuit incorporating one or more of the components illustrated in FIG. 6. In one example, an SoC can comprise multiple processor cores, cache memory, a display driver, a GPU, multiple I/O controllers, an AI accelerator, an image processing unit driver, I/O controllers, an AI accelerator, an image processor unit. Further, a computing device can connect elements via bus or point-to-point configurations different from that shown in FIG. 6. Moreover, the illustrated components in FIG. 6 are not required or all-inclusive, as shown components can be removed and other components added in alternative embodiments.

As used in any embodiment herein, the term “module” refers to logic that may be implemented in a hardware component or device, software or firmware running on a processor, or a combination thereof, to perform one or more operations consistent with the present disclosure. Software may be embodied as a software package, code, instructions, instruction sets and/or data recorded on non-transitory computer-readable storage mediums. Firmware may be embodied as code, instructions or instruction sets and/or data that are hard-coded (e.g., nonvolatile) in memory devices. As used in any embodiment herein, the term “circuitry” can comprise, for example, singly or in any combination, hardwired circuitry, programmable circuitry such as computer processors comprising one or more individual instruction processing cores, state machine circuitry, and/or firmware that stores instructions executed by programmable circuitry. Modules described herein may, collectively or individually, be embodied as circuitry that forms a part of one or more devices. Thus, any of the modules can be implemented as circuitry, such as continuous itemset generation circuitry, entropy-based discretization circuitry, etc. A computer device referred to as being programmed to perform a method can be programmed to perform the method via software, hardware, firmware or combinations thereof.

The use of reference numbers in the claims and the specification is meant as in aid in understanding the claims and the specification and is not meant to be limiting.

Any of the disclosed methods can be implemented as computer-executable instructions or a computer program product. Such instructions can cause a computer or one or more processors capable of executing computer-executable instructions to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible or non-transitory computer-readable storage media, such as optical media discs (e.g., DVDs, CDs), volatile memory components (e.g., DRAM, SRAM), or non-volatile memory components (e.g., flash memory, solid state drives, chalcogenide-based phase-change non-volatile memories). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components.

The computer-executable instructions can be part of, for example, a dedicated software application or a software application that is accessed via a web browser or other software application (such as a remote computing application). Such software can be read and executed by, for example, a single computing device or in a network environment using one or more networked computers. Further, it is to be understood that the disclosed technology is not limited to any specific computer language or program. For instance, the disclosed technologies can be implemented by software written in C++, Java, Perl, Python, JavaScript, Adobe Flash, or any other suitable programming language. Likewise, the disclosed technologies are not limited to any particular computer or type of hardware.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items joined by the term “and/or” can mean any combination of the listed items. For example, the phrase “A, B and/or C” can mean A; B; C; A and B; A and C; B and C; or A, B, and C. Further, as used in this application and in the claims, a list of items joined by the term “at least one of” can mean any combination of the listed terms. For example, the phrase “at least one of A, B, or C” can mean A; B; C; A and B; A and C; B and C; or A, B, and C. Moreover, as used in this application and in the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Certain non-limiting examples of the presently described techniques are provided below. Each of the following non-limiting examples may stand on its own or may be combined in any permutation or combination with any one or more of the other examples provided below or throughout the present disclosure.

Example 1 is an apparatus comprising: a housing; a keyboard coupled to the housing; and a flap coupled to the housing, the flap being moveable between a first position that is generally parallel to keys of the keyboard and a second position that is at an angle less than 90 degrees with respect to the keys of the keyboard, the flap comprising touch sensing circuitry and a liquid crystal layer.

Example 2 includes the apparatus of Example 1, further comprising circuitry to control the liquid crystal layer to be generally transparent in the first position and generally opaque in the second position.

Example 3 includes the apparatus of Example 1 or 2, wherein the housing comprises a plurality of openings and at least one light emitting element positioned beneath each respective opening, the flap positioned above the openings of the housing.

Example 4 includes the apparatus of Example 3, further comprising photochromatic paint adjacent to the openings of the housing.

Example 5 includes the apparatus of Example 3 or 4, wherein the liquid crystal layer comprises openings in areas around each of the openings of the housing.

Example 6 includes the apparatus of any one of Examples 1-5, wherein the liquid crystal layer is on a top surface of the flap and the touch sensing circuitry is on a bottom surface of the flap.

Example 7 includes the apparatus of Example 6, wherein the liquid crystal layer comprises polymer dispersed liquid crystals.

Example 8 includes the apparatus of any one of Examples 1-7, wherein the flap is coupled to the housing via a hinge.

Example 9 includes the apparatus of Example 8, wherein an end of the flap opposite the hinge has a curvature.

Example 10 includes the apparatus of Example 9, wherein the flap comprises one or more visual indicators on the curvature.

Example 11 includes the apparatus of Example 10, wherein visual indicators protrude from the flap.

Example 12 includes the apparatus of any one of Examples 1-11, wherein the keyboard comprises mechanically actuated keys.

Example 13 includes the apparatus of any one of Examples 1-12, further comprising a processor and memory.

Example 14 is an apparatus comprising: a keyboard; touch sensitive buttons adjacent to the keyboard; and photochromatic paint adjacent to the touch sensitive buttons.

Example 15 includes the apparatus of Example 14, further comprising: a flap being moveable between a first position that is generally parallel to keys of the keyboard and a second position that is at an angle less than 90 degrees with respect to the keys of the keyboard, the flap comprising a liquid crystal layer; and circuitry to control the liquid crystal layer to be generally transparent in the first position and generally opaque in the second position.

Example 16 includes the apparatus of Example 15, wherein the liquid crystal layer comprises openings in areas around each of the touch sensitive buttons.

Example 17 includes the apparatus of Example 15 or 16, wherein the liquid crystal layer comprises polymer dispersed liquid crystals.

Example 18 includes the apparatus of any one of Examples 15-17, wherein the flap is coupled via a hinge.

Example 19 includes the apparatus of any one of Examples 14-18, further comprising a processor and memory.

Example 20 includes the apparatus of any one of Examples 14-19, wherein the keyboard comprises mechanically actuated keys.

Example 21 is a computing device comprising: a lid; a base coupled to the lid, comprising: a keyboard; a plurality of openings adjacent to the keyboard; at least one light emitting element positioned below each respective opening; a flap above the plurality of openings, the flap being moveable between a first position that is generally parallel to a top surface of the base and a second position that is at an angle less than 90 degrees with respect to the top surface of the base, the flap comprising touch sensing circuitry in areas adjacent to the respective openings and a liquid crystal layer; and circuitry to cause the liquid crystal layer to be generally transparent in the first position and generally opaque in the second position.

Example 22 includes the computing device of Example 21, wherein the flap is coupled to the base via a hinge.

Example 23 includes the computing device of Example 22, wherein an end of the flap opposite the hinge has a curvature.

Example 24 includes the computing device of Example 23, wherein the flap comprises one or more visual indicators on the curvature.

Example 25 includes the computing device of any one of Examples 21-24, wherein the liquid crystal layer is on a top surface of the flap.

Example 26 includes the computing device of any one of Examples 21-25, wherein the liquid crystal layer comprises polymer dispersed liquid crystals.

Example 27 includes the computing device of any one of Examples 21-26, further comprising photochromatic paint adjacent to the openings.

Example 28 includes the computing device of any one of Examples 21-27, further comprising a processor and memory in the base, and a display in the lid.

Example 29 includes the computing device of any one of Examples 21-28, wherein the keyboard comprises mechanically actuated keys.

Example 30 is an apparatus comprising: a keyboard; icons adjacent to the keyboard, each respective icon indicating a respective function; photochromatic paint adjacent to the icons; and a flap above the icons, the flap comprising a transparent body and touch sensing circuitry corresponding to the functions indicated by the icons.

Example 31 includes the apparatus of claim 30, wherein the flap comprises a liquid crystal layer and the apparatus further comprises circuitry to control the liquid crystal layer to be generally transparent when the flap is approximately parallel to keys of the keyboard and generally opaque when the flap is at an angle less than 90 degrees with respect to the keys of the keyboard.

Example 32 includes the apparatus of claim 31, wherein the liquid crystal layer comprises openings in areas around each of the icons.

Example 33 includes the apparatus of claim 31, wherein the liquid crystal layer comprises polymer dispersed liquid crystals.

1. An apparatus comprising:
a housing;
a keyboard coupled to the housing; and
a flap coupled to the housing, the flap being moveable between a first position that is generally parallel to keys of the keyboard and a second position that is at an angle less than 90 degrees with respect to the keys of the keyboard, the flap comprising touch sensing circuitry and a liquid crystal layer.

2. The apparatus of claim 1, further comprising circuitry to control the liquid crystal layer to be generally transparent in the first position and generally opaque in the second position.

3. The apparatus of claim 1, wherein the housing comprises a plurality of openings and at least one light emitting element positioned beneath each respective opening, the flap positioned above the openings of the housing.

4. The apparatus of claim 3, further comprising photochromatic paint adjacent to the openings of the housing.

5. The apparatus of claim 3, wherein the liquid crystal layer comprises openings in areas around each of the openings of the housing.

6. The apparatus of claim 1, wherein the liquid crystal layer is on a top surface of the flap and the touch sensing circuitry is on a bottom surface of the flap.

7. The apparatus of claim 6, wherein the liquid crystal layer comprises polymer dispersed liquid crystals.

8. The apparatus of claim 1, wherein the flap is coupled to the housing via a hinge.

9. The apparatus of claim 8, wherein an end of the flap opposite the hinge has a curvature.

10. The apparatus of claim 9, wherein the flap comprises one or more visual indicators on the curvature.

11. The apparatus of claim 10, wherein visual indicators protrude from the flap.

12. The apparatus of claim 1, further comprising a processor and memory.

13. An apparatus comprising:
a keyboard;
icons adjacent to the keyboard, each respective icon indicating a respective function;
photochromatic paint adjacent to the icons; and
a flap above the icons, the flap comprising a transparent body and touch sensing circuitry corresponding to the functions indicated by the icons.

14. The apparatus of claim 13, wherein the flap comprises a liquid crystal layer and the apparatus further comprises circuitry to control the liquid crystal layer to be generally transparent when the flap is approximately parallel to keys of the keyboard and generally opaque when the flap is at an angle less than 90 degrees with respect to the keys of the keyboard.

15. The apparatus of claim 14, wherein the liquid crystal layer comprises openings in areas around each of the icons.

16. The apparatus of claim 14, wherein the liquid crystal layer comprises polymer dispersed liquid crystals.

17. A computing device comprising:
a lid;
a base coupled to the lid, comprising:
a keyboard;
a plurality of openings adjacent to the keyboard;
at least one light emitting element positioned below each respective opening;
a flap above the plurality of openings, the flap being moveable between a first position that is generally parallel to a top surface of the base and a second position that is at an angle less than 90 degrees with respect to the top surface of the base, the flap comprising touch sensing circuitry in areas adjacent to the respective openings and a liquid crystal layer; and
circuitry to cause the liquid crystal layer to be generally transparent in the first position and generally opaque in the second position.

18. The computing device of claim 17, wherein the flap is coupled to the base via a hinge at a first end of the flap, an end of the flap opposite the hinge has a curvature, and the flap comprises one or more visual indicators on the curvature.

19. The computing device of claim 17, wherein the liquid crystal layer is on a top surface of the flap.

20. The computing device of claim 17, further comprising photochromatic paint adjacent to the openings.
